(19) United States
(12) Patent Application Publication
(10) Pub. No.: US 2017/0286762 A1
(43) Pub. Date: Oct. 5, 2017

(54) SECURITY CAMERA SYSTEM WITH PROJECTILE TECHNOLOGY

(71) Applicant: JOHN RIVERA, MELBOURNE, FL (US)

(72) Inventor: JOHN RIVERA, MELBOURNE, FL (US)

(21) Appl. No.: 15/470,538

(22) Filed: Mar. 27, 2017

Related U.S. Application Data
(60) Provisional application No. 62/313,254, filed on Mar. 25, 2016.

(51) Int. Cl. G06K 9/00; F41A 19/58; H04N 5/225; F41A 23/24; G08B 13/196

(52) U.S. Cl. CPC G06K 9/00362; F41A 23/24; G08B 13/19684; G06K 9/00771; G08B 13/19608; H04N 5/2251; F41A 19/58

(57) ABSTRACT

A security camera and weapon system. The system comprises a camera for capturing images of an area and a display screen for displaying those images. A weapon is co-located with the camera and controllable by a user to fire a projectile. The weapon comprises primer contacts in contact with a projectile primer which is in contact with a propellant. The user controls application of a voltage to the primer contacts, thereby igniting the primer and the propellant and firing the projectile from a weapon barrel. The weapon is aimed and fired by the user from a system controller based on images captured by the camera and presented on the display screen, the images are overlaid with projectile aiming indicia.

### CROSS REFERENCE TO RELATED APPLICATIONS

This patent application claims the benefit of U.S. provisional patent application filed on Mar. 25, 2016 and assigned Application No. 62/313,254, which is incorporated herein in its entirety.

### BACKGROUND OF THE INVENTION

Wireless security cameras are closed-circuit television (CCTV) cameras that transmit a video and audio signal to a wireless receiver through a radio frequency channel. Many wireless security cameras require at least one cable or wire for power; “wireless” refers to the transmission of video/audio. However, some wireless security cameras are battery-powered, making the cameras truly wireless.

Wireless cameras are proving very popular among modern security consumers due to their low installation costs. Wireless cameras can be mounted/installed in locations previously unavailable to standard wired cameras. In addition to the ease of use and convenience of access, a wireless security camera system allows users to leverage broadband wireless internet access to provide seamless video streaming over the internet.

Analog wireless is the transmission of data, audio, and video signals using radio frequencies and analog modulation. Typically, analog wireless transmissions have a transmission range of around 300 feet in open space; walls, doors, and furniture reduce this range.

Analog wireless is found in three frequencies: 900 MHz, 2.4 GHz, and 5.8 GHz. Currently, the majority of wireless security cameras operate on the 2.4 GHz frequency. Most household routers, cordless phones, video game controllers, and microwaves operate on the 2.4 GHz frequency and may cause interference with a wireless security camera. 900 MHz is referred to as “Wi-Fi Friendly” because it will not interfere with the Internet signal of a wireless network.

### BRIEF DESCRIPTION OF THE FIGURES

The skilled artisan will understand that the drawings, as described below, are for illustration purposes only. The drawings are not intended to limit the scope of the present invention in any way. Several of the Figures are block diagrams that depict the components necessary for the operation of the invention.

FIG. 1 illustrates a rear surface of a projectile (bullet) for use with the present invention.

FIG. 2 depicts a cross-sectional view of the bullet of FIG. 1.

FIG. 3 depicts a close up view of certain elements shown in FIG. 2.

FIG. 4 depicts various types of bullets for use with the system of the present invention.

FIG. 5 depicts an embodiment of an electronic firing system, including an electronic schematic, for use with the present invention.

FIG. 6 depicts a close-up view of certain components of FIG. 5.

FIG. 7 depicts the elements illustrated in FIGS. 2 and 5.

FIG. 8 depicts a security camera system and a projectile firing device.

FIGS. 9 and 10 depict display images associated with the present invention.

FIG. 11 depicts a combination security camera and firing system of the present invention.

FIG. 12 depicts a block diagram of the system of the present invention.

### DETAILED DESCRIPTION OF THE INVENTION

Before describing in detail the particular methods and apparatuses related to a security camera including projectile technology, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the inventions.

The presented embodiments are not intended to define limits as to the structures, elements or methods of the inventions, but only to provide exemplary constructions. The embodiments are permissive rather than mandatory and illustrative rather than exhaustive.

Wireless analog security cameras are cost effective as such a camera is relatively inexpensive. A camera can support multiple receivers; the signal from one camera can be received by any designated receiver(s). Also, multiple receivers in various locations form a wireless surveillance network.

However, analog security cameras also have disadvantages. They are susceptible to interference from other household devices, such as microwaves, cordless phones, video game controllers, and routers. Analog cameras lack signal strength indicators, such as a visual alert provided by the bars on a mobile phone). These cameras are susceptible to interception Also, because analog wireless signals are sent on a fixed frequency, it is possible for the signals to be picked up by other receivers. Only one-way communication is available; it is not possible for the receiver to send signals back to the camera.

Digital wireless cameras transmit audio and video signals, encoded as digital packets, over high-bandwidth radio frequencies. Their advantages include:
Wide transmission range—usually close to 450 feet (open space, clear line of sight between camera and receiver)
High quality video and audio
Two-way communication between the camera and the receiver
Using digital signaling allows the transmission of commands and functions, such as turning lights on and off.
Multiple receivers can be connected to one recording device, such as security digital video recorder.

Wireless security systems are becoming more and more popular in the consumer market as a cost-effective technique for constructing a comprehensive surveillance system in a home or business.

Wireless cameras are also ideal for people living in a rented home or apartment since there is no need to run video cables through walls or ceilings, from the camera to the receiver or recording device. A user does not need approval of a landlord to install a wireless security camera system. A wireless security system camera is also suitable for seasonal monitoring and surveillance.

Wireless cameras are also very useful for monitoring outdoor buildings as wireless signals can be sent from one building to another where it is not possible to run wires due to interfering roads or other obstructions. One common use of such cameras is watching animals in a barn from a house located on the same property.

Wireless security cameras are also used by law enforcement agencies to deter crimes. The cameras can be installed in many remote locations and the video data transmitted through a secure for-government-only wireless network. An example of this application is the deployment of hundreds of wireless security cameras by New York City Police Department on lampposts at many locations throughout the city.

Wireless security cameras function best when there is a clear line of sight between the camera(s) and the receiver. When located outdoors with clear line of sight to the receiver, digital wireless cameras typically have a range between 250 to 450 feet.

Indoors, the range can be limited to 100 to 150 feet as cubical walls, drywall, glass, and windows generally do not degrade wireless signal strength but brick, concrete floors, and walls degrade the signal strength. Trees in the line of sight of the wireless camera and receiver may impact signal strength and thus the signal range. The signal range also depends on whether there are competing signals on the same frequency or a nearby frequency. For example, signals from cordless phones or routers may affect signal range. When interference occurs, the camera image may freeze, or appear “choppy”.

Various types of security cameras and their key features are described below. Particular or various aspects of each camera type may best suit the solution of a particular need.

Often requiring professional installation, wired security cameras must be located in places where they can be connected to necessary terminals for power and signal. The wires may be difficult to hide, making surveillance obvious to an intruder, who will then try to stay beyond camera range. Wired cameras may offer a clearer picture than wireless cameras, as well as better data streaming. However, outdoor security cameras may fail or at least their operation compromised by weather and other outdoor vulnerabilities.

Wireless cameras are ideal for outdoor installation, which can be otherwise challenging as described above. Powered by batteries, rather than with wires extending from a power source (that often restrict placement), wireless cameras are quite versatile, covert (no visible wires), easy to install, and easy to relocate as needed.

While both color and black and white cameras are available, color security cameras are more extensive but provide a higher quality or higher resolution image. A black and white image captures light versus dark tones compared to precise color images captured by a color camera. To identify an intruder, for example, elements such as the color of clothing, skin, eyes and hair can make a significant difference.

Depending on the area to be surveyed, a wide-angle lenses may be preferred. Using one or more wide-angle lenses cameras likely reduces the number of cameras needed. Backyard areas are ideal for a wide-angle lenses camera, which can cover 104 degrees of movement at up to 40 feet away.

Named for its streamlined, bullet shape, a bullet camera is best suited to a wall or ceiling mount and pointed in one direction, making it ideal for entrances, such as a porch area. Bullet cameras typically do not have the capability to change direction or zoom in. From an intruder's perspective, it is easy to see the direction in which the camera is pointed, thereby facilitating the avoidance of detection.

Dome shaped cameras are designed to be an “in-your-face” type of protection. Very obvious in their purpose, dome cameras are also most suited to a more protected entryway type mount so they are immediately visible to anyone who approaches. Unlike the bullet camera, it is difficult to determine the direction in which the camera is pointed. This feature increases the deterrent nature of the camera. A speed dome camera can spin quickly to capture a broader range of images.

A discreet camera, a polar opposite of the obvious dome cameras, is disguised as typical outdoor accouterments such as a clock, a plant, or an electrical box. Alternatively, any camera can be well hidden inside a planter or in a tree to obscure notice.

Infrared/night vision cameras can capture images and video in shadows, shady areas, and on the darkest of nights using infrared LEDs. These cameras are highly desirable for outdoor security since nighttime often heightens one's need to feel secure. And intruders may think they can escape detection during nighttime hours.

Every outdoor camera should include some degree of protection from the weather and other outdoor elements. Such weather resistant cameras are available in all degrees of “weather resistance,” including every type climate, rain, freezing temperatures, hot temperatures and heavy winds. A hood can be used to protect the lens and avoid its obstruction by precipitation. Some weather resistant cameras include thermostatic controls, which can heat or cool or cool the camera to prevent condensation from forming over the lens. It is also preferable that outdoor cameras be secure against dust, insects, and ultraviolet sunrays, and be vandal-proof as well.

Because the extent of daylight and the impact of artificial outdoor lighting are always changing, outdoor cameras must be able to adapt to varying degrees of glare, reflections, backlight, shadows and complete darkness.

Pan, tilt and zoom (PTZ) cameras are ideal for outdoor coverage of a large area, as the PTZ camera has the ability to move and capture different angles. These features allow a limited number of PTZ cameras to replace a greater number of fixed-site cameras. Movement of a PTZ security camera can be pre-programmed or controlled by an operator from a remote location.

All over America we are faced with ever-increasing threats of violence and property damage. Home invasions are up as well as terrorist attacks in some of our most sacred places such as university campuses, churches, day schools, movie theaters, shopping malls and places of work.

The present invention comprising a security camera with projectile technology allows for homes and building to not only see and video record an intruder or another threat, but also to offer a response to a threatening situation. This invention provides anyone with the much-needed ability to asses and respond to an imminent threat from the moment that a 911 emergency call is placed, or even prior thereto. This technology may be especially important for those who live in rural areas.

The invention permits viewing, assessing and responding to whatever danger is lurking outside or inside the home and allows a lethal or non-lethal response, as necessary. The system can be operated, when alerted, by using a software application through one's smart phone or another personal or otherwise electronic device by simply performing a gesture on a smart screen.

The technology can also be used on a larger scale by qualified law enforcement agencies or other qualified personnel, in buildings such as schools and universities, with multiple locations monitored by a central onsite or off-site facility. Corporate and government buildings with qualified private security forces can also advantageously employ this technology.

The present invention is a new and dynamic wireless or wired digital or analog PTZ camera system, with the following capabilities in its various embodiments:
infrared night vision technology
pan, tilt and zoom capabilities
completely discreet
weather resistant
spinning or rotating quickly
operational on a private or government-only wireless network
controllable from a smart phone or smart device using a software application
indoor and/or outdoor application or deployment
controllable by an operator from a remote location
adaptable to integration into a larger surveillance network
capable of firing a lethal or non-lethal projectile

This embodiment includes an electronic bullet and firing system that is electronically integrated into the overall surveillance camera operation. It provides the ability for the camera system user/operator to surveil the camera's area of view to assess the nature of the threat, focus in on the threat, give a verbal command to cease and desist all activities and or leave the area immediately or failing to do so be subject to a lethal or non-lethal force. Should the threat not heed the warnings or commands to cease and desist all activity and if there is probable cause or reason to take additional action, the camera system user/operator has the ability to focus the target into the cross hairs on the camera lens, for greater accuracy, and fire a single or multiple bullet round(s) lethal or non-lethal by engaging and firing the electronic firing system at the threat.

This entire system incorporates camera technology, a new wireless application system (APP) as well as a new electronic bullet and firing system. The totality of all three systems comprise the “Security Camera with Projectile Technology”.

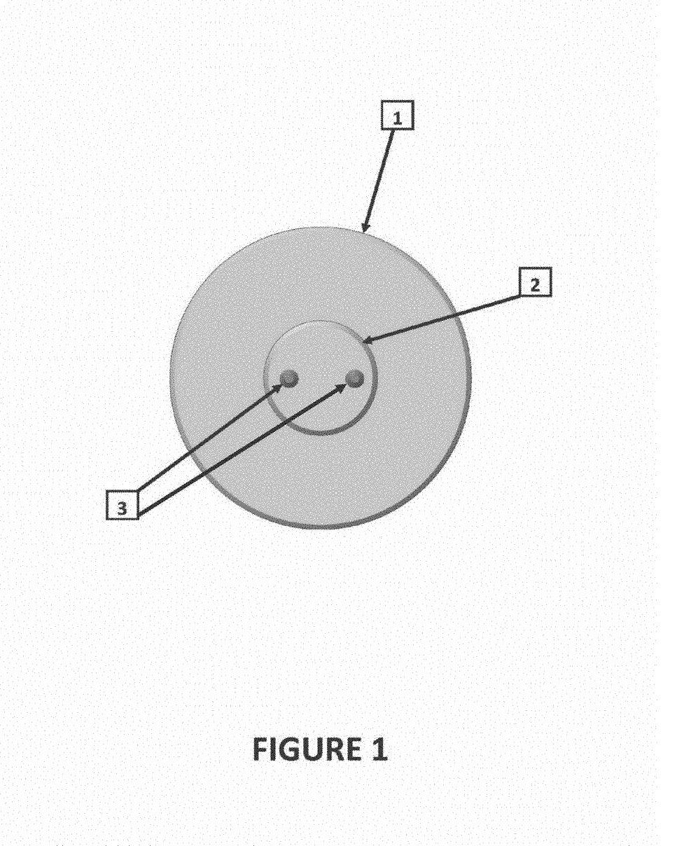

FIG. 1 depicts a bullet for use with the electronic firing system of the invention, including a bottom surface of a shell casing 1, an exterior primer 2, and exterior contacts 3.

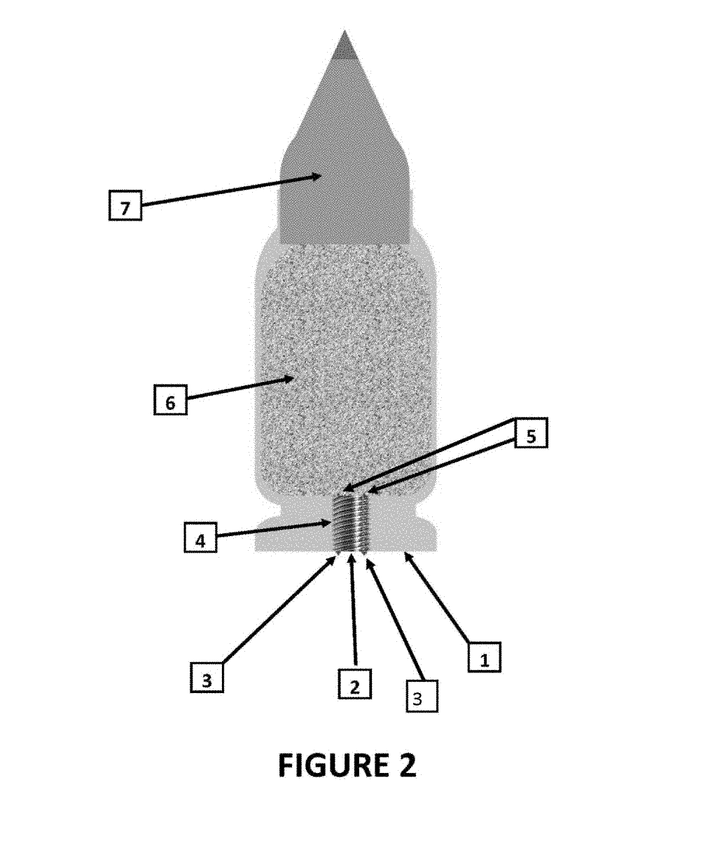

FIG. 2 depicts an interior cross-section of the bullet of FIG. 1 depicting the shell casing 1, the exterior primer 2, the exterior contacts 3, the interior primer 4, an interior primer 4, interior electrical contacts 5, a propellant 6, and a projectile 7.

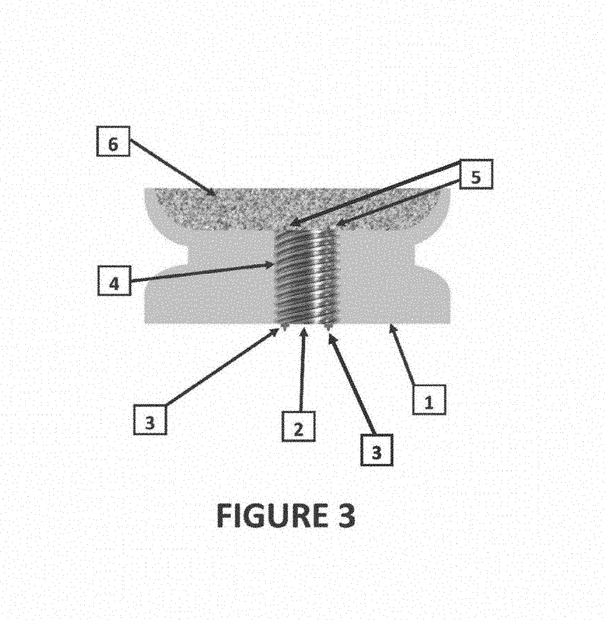

FIG. 3 depicts a close-up view of FIG. 2, including the shell casing 1, the exterior primer 2, the exterior contacts 3, the interior primer 4, and the propellant 6.

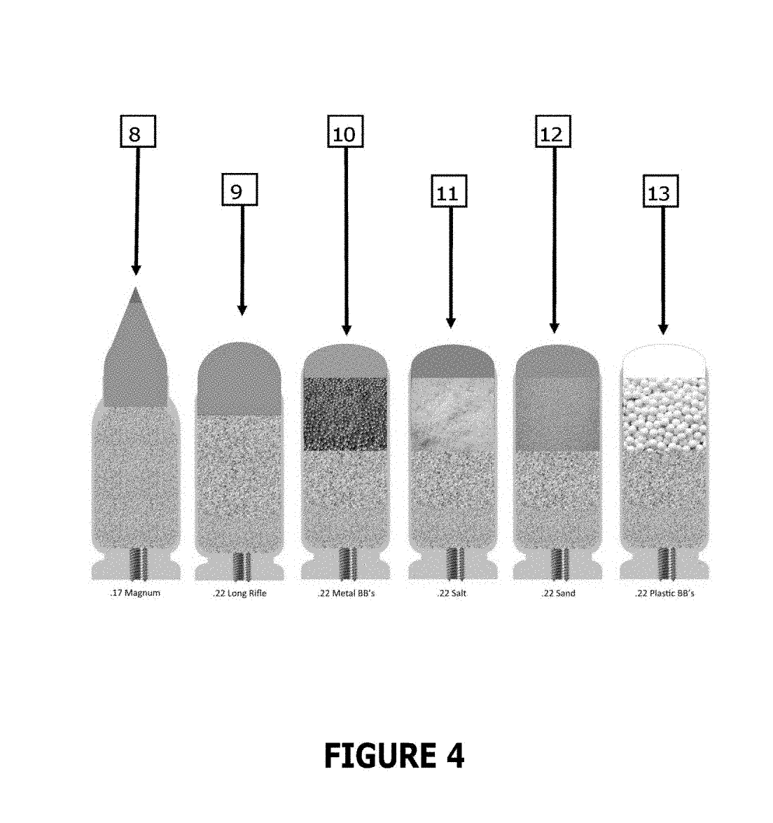

FIG. 4 depicts the various types of bullets and projectiles that can be adapted for use with the electronic components of the FIG. 2 embodiment. The .17 magnum is a high velocity solid metal lethal projectile 8, the .22 short and long rifle is a standard velocity solid metal lethal projectile 9, the .22 metal BB's is a standard velocity mini metal pellets non-lethal projectile 10, the .22 salt is a standard velocity mini rock salt non-lethal projectile 11, the .22 sand is a standard velocity granular sand non-lethal projectile 12, and the .22 plastic BB's is a standard velocity mini plastic pellets non-lethal projectile 13. Each of these bullets are color coded on their tips to distinguish their respective projectile content. Larger caliber bullets than those illustrated may also be utilized with attendant changes in the electronic firing system.

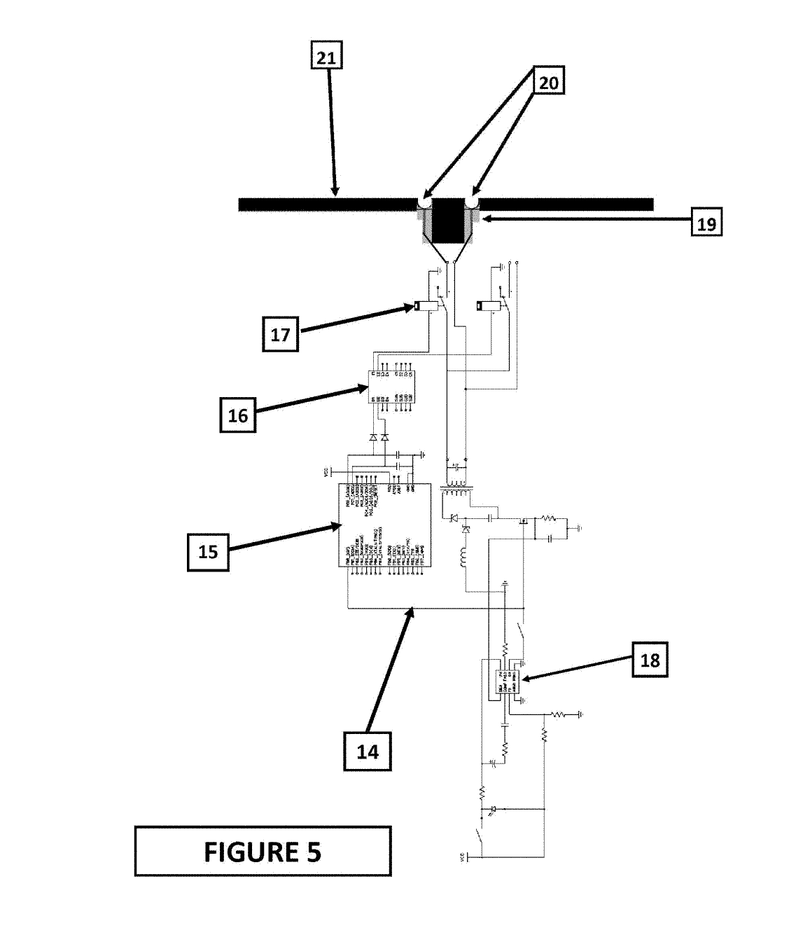

FIG. 5 depicts the embodiment of the electronic circuit (schematic) and docking components (for holding the electronic components in contact with the electronic firing system). Reference numeral 15 is a processor that controls the firing output of the device and also counts the number of trigger fires (the number of presses on the firing button or switch) and determines the output. The first press fires the first projectile and the second press fires the second projectile. The processor also controls and/or prevents miss-fires. A reference numeral 14 depicts a signal wire coming from the firing switch (trigger). A reference numeral 16 depicts a current driver, which steps up the current to feed relays 17 and 18 so that they are at a sufficient load current/voltage to properly ignite the propellant to fire the projectile. All of the illustrated components, when activated, send electrical current to the bullet by through wires that carry the current through the insulators 19 to the contact ports 20 which are housed in the bullet docking port 21, and then to the exterior contacts 3, as depicted in FIG. 2.

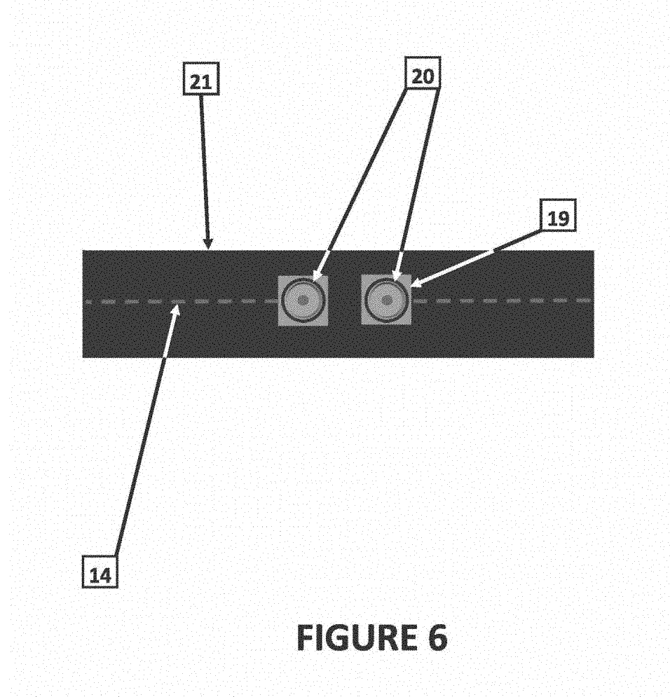

FIG. 6 depicts a close-up view of the bullet docking port 21, wire insulation 19, conductors 14 and the contact ports 20, into which the exterior electrical contacts 3 are inserted.

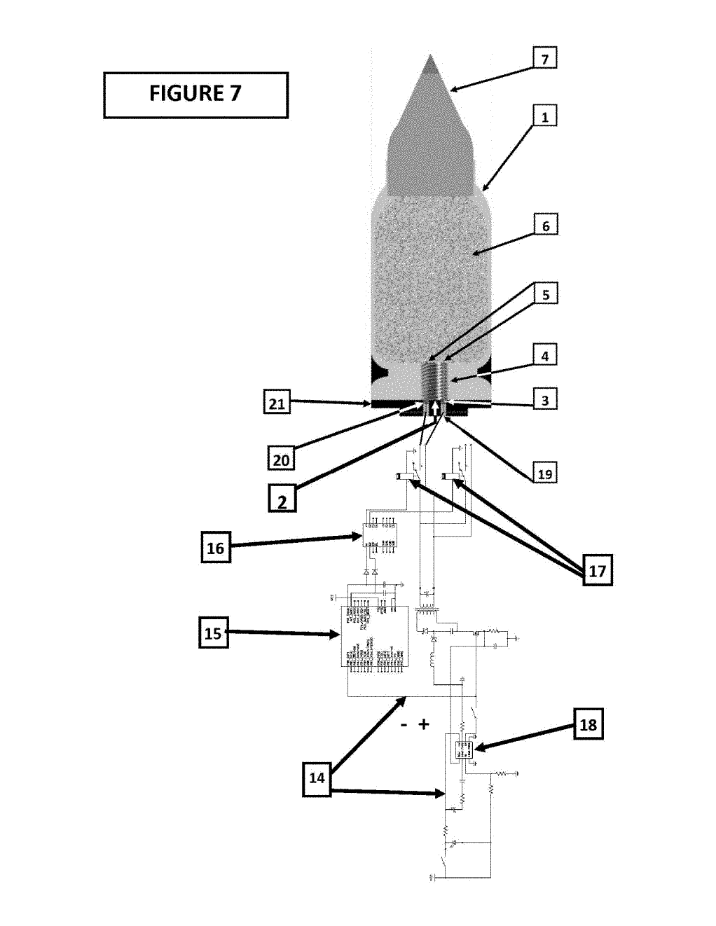

FIG. 7 depicts the elements of FIGS. 2 and 5, i.e., the bullet and the electronic circuits that ignite the propellant inside the bullet to fire the projectile.

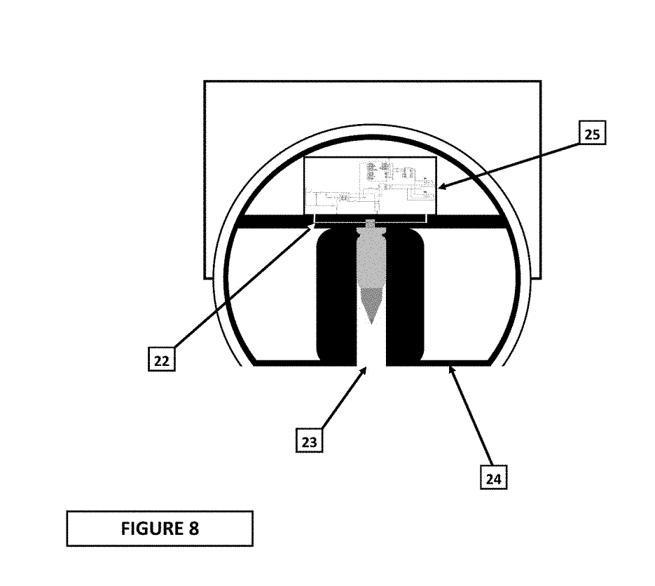

FIG. 8 depicts the elements of FIGS. 2 and 5 in a single barrel configuration disposed inside a security camera 24. Current flows through wires 22 to the exterior contacts 3 (not shown in FIG. 8). When a firearm device 25 receives a command or function directive (an electronic signal) to fire the projectile, current is made to flow through the wires 22 to the exterior contacts 3 to ignite the primer 4 and cause the projectile 7 to exit through a barrel 23. In one embodiment, the command or directive is initiated from a proprietary touch screen application software resident on a smart phone or other touch screen operational device.

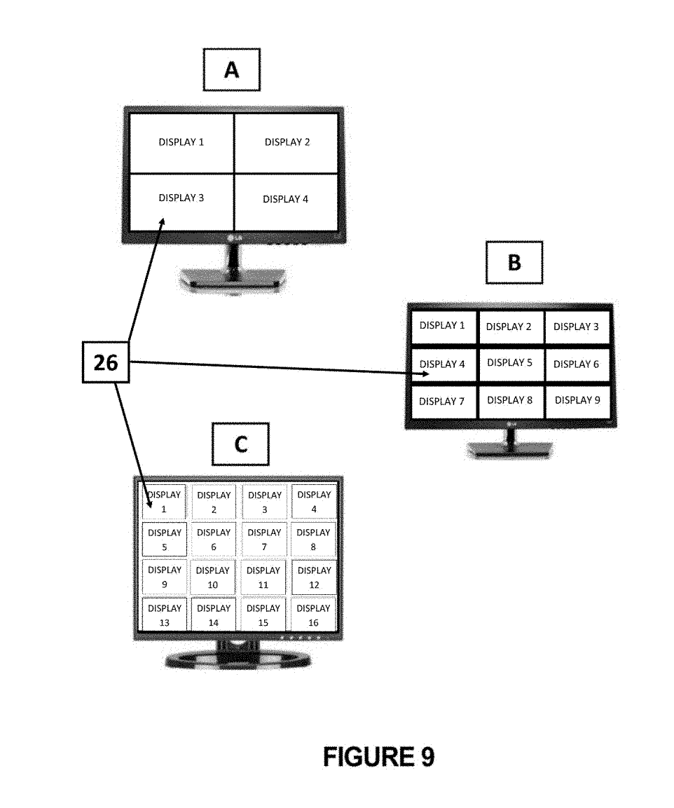

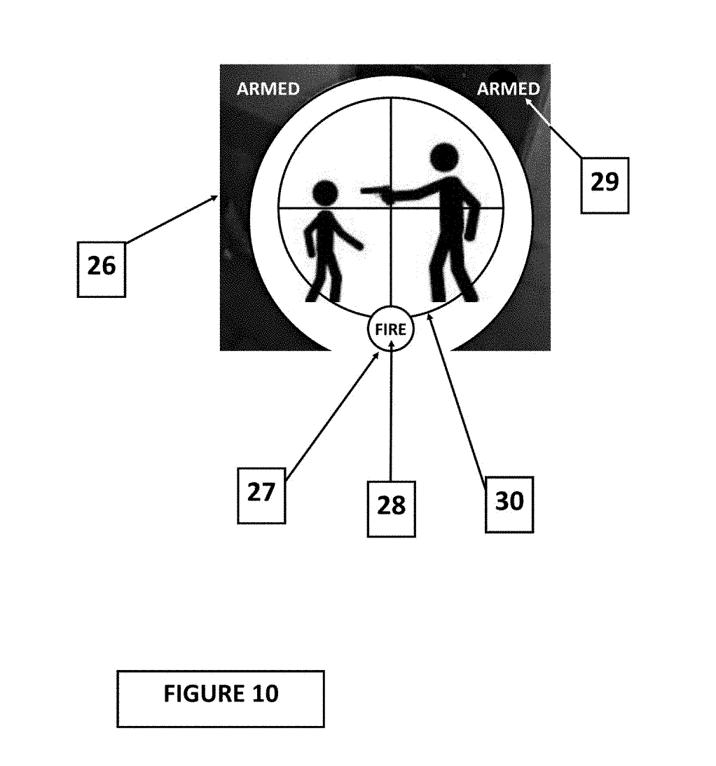

FIGS. 9A, 9B, and 9C each depict a varied number of camera displays 26, depending on the number of cameras in use. These images can be displayed on a monitor or smart phone or another viewable device. To fire the projectile the user/operator must first select the camera display screen by touching the display screen or choosing the desired camera through another control device. This action activates and isolates the camera image on the screen. Isolating it on the screen means that no other camera is displayed at that time. See FIG. 10.

Once isolated, a colored (preferably red) virtual firing button 27 appears on a lower region of the screen with the word “FIRE” 28 displayed in the button 27. On an upper region of the screen the word “ARMED” 29 appears. In FIG. 10 the word “ARMED” appears at two locations on the upper region. A circle (red on one embodiment) with cross hairs depicts a target area 30. The center of the cross hairs can be moved directly over the target by touching the smart device screen and scrolling the target cross hairs into the desired location.

Before firing a projectile at the subject as viewed in the camera, the user/operator has ability to first warn the subject verbally to cease and desist and or vacate the area immediately by speaking into a mobile phone microphone, a smart device microphone, or a microphone located at a remote surveillance control center. The warning will be transmitted to the camera as selected on the screen and will be heard at the location of the camera through a micro speaker co-located with or attached to the camera.

If the warning is not heeded or the threat continues, the user/operator has the option to fire a projectile (bullet) by touching the red firing button 28 on the screen. Once the red button is touched a command or function (electronic signal) is sent to the security camera chosen on the screen and a lethal or non-lethal projectile is fired at the subject in the camera display cross hairs.

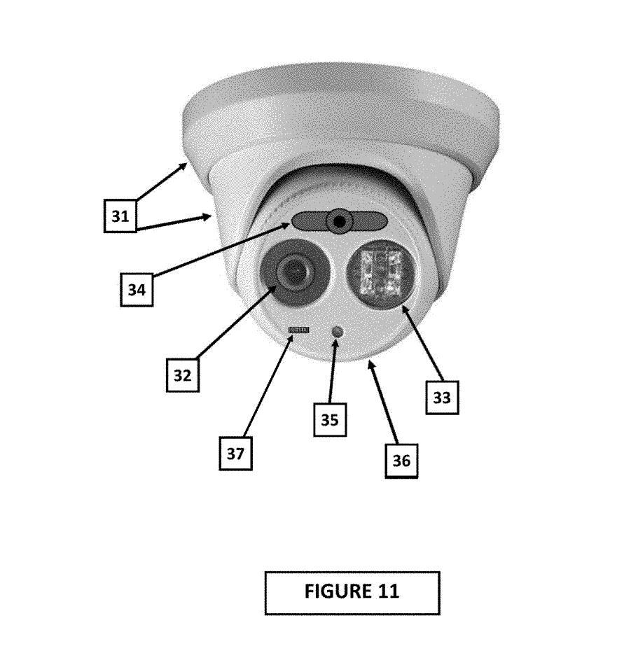

FIG. 11 depicts the external view of the camera housing 31, the lens 32, the infrared sensor 33, the projectile barrel 34, the photo cell sensor 35 and the system 36. A DVR recorder terminal is indicated reference numeral 37.

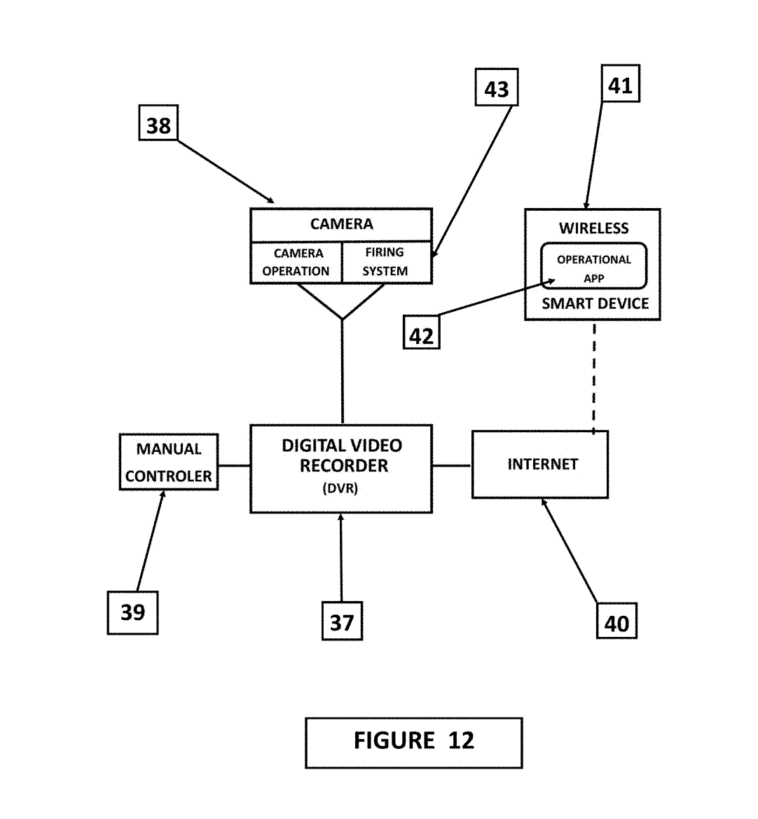

FIG. 12 is an overall block diagram of the operational system. 37 is representative of a pan, tilt, and zoom digital video recorder (DVR) camera. The DVR records video of the camera image. The DVR houses all of the electronic components used to operate the camera.

Connected to this device are the cameras 38 (preferably mounted in multiple locations), the manual controller 39, and the internet data transmission system 40. The manual controller 39 is hard wired into the DVR/camera for sending commands to the camera to perform certain task such as to pan, tilt, zoom, focus, center the cross hairs, and to electronically fire a projectile at a threat.

The internet 40 is attached to the DVR/camera through a modem device. This is needed to communicate commands from a wireless device such as a smart phone or ipad 41. The smart device will communicate wirelessly by way of a radio frequency signal and/or a website on the World Wide Web or internet with the DVR/camera 37 through a user application (APP) 42. The APP 42 can be down loaded from a web site on the internet 40. The APP 42 mirrors the manual controller in its functional capability and in fact represents a wireless form of the manual controller 39.

The camera 38 is capable of receiving commands through the DVR from either the wireless device 41 or the manual controller 39.

In one embodiment, the electronic bullet and firing system 43 is intergraded into current DVR technology, which provides the ability to surveil, communicate and neutralize a threat using lethal and non-lethal means by way of a hard-wired system or wireless system.

Generally, the images referred to herein comprise full motion or video images as captured by the camera(s). Still images can also be captured but these tend to be less useful for surveillance purposes.

In one embodiment, the weapon (i.e., the barrel through which the projectile travels) and the camera are separately controllable to point or aim in different directions.

An exemplary system for implementing certain aspects of the invention includes a computing device or a network of computing devices. In a basic configuration, computing device may include any type of stationary computing device or a mobile computing device. Computing device typically includes at least one processing unit and system memory.

Depending on the exact configuration and type of computing device, system memory may be volatile (such as RAM), non-volatile (such as ROM, flash memory, and the like) or some combination of the two. System memory typically includes operating system, one or more applications, and may include program data.

Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. Computing device may also have input device(s) such as a keyboard, mouse, pen, voice input device, touch input device, etc. Output device(s) such as a display, speakers, printer, etc. may also be included.

Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code or applications code (an “app” for example) for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage.

It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general-purpose computer, but rather the special purpose computer programmed to perform the disclosed algorithm.

A general-purpose computer, or microprocessor, may be programmed to carry out the algorithm/steps of the present invention creating a new machine. The general-purpose computer becomes a special purpose computer once it is programmed to perform particular functions pursuant to instructions from program software of the present invention. The instructions of the software program that carry out the algorithm/steps electrically change the general-purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application.

Although the invention has been shown and described with respect to a certain preferred embodiment or embodiments, equivalent alterations and modifications may occur to others skilled in the art upon the reading and understanding of this specification and the annexed drawings. In particular regard to the various functions performed by the above described components (assemblies, devices, circuits, etc.), the terms used to describe such components are intended to correspond, unless otherwise indicated, to any component that performs the specified function of the described component (i.e., that is functionally equivalent), even though not structurally equivalent to the disclosed structure, which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A security camera and weapon system, comprising:
a camera for capturing images of an area;
a display screen for displaying images captured by the camera;
a weapon co-located with the camera and controllable by a user to fire a projectile, the weapon comprising primer contacts in contact with a projectile primer in contact with a propellant, the user controlling application of a voltage to the primer contacts thereby igniting the primer and the propellant and firing the projectile from a weapon barrel; and
the weapon aimed and fired by the user from a system controller based on images captured by the camera and presented on the display screen, the images overlaid with projectile aiming indicia.

2. The security camera and weapon system of claim 1, the projectile comprising:
a shell casing enclosing the projectile primer and the propellant;
the primer contacts on an outside surface of the shell casing, the voltage applied to the primer contacts; and
application of the voltage to the primer contacts ignites the projectile primer and thereby the propellant, causing the projectile to be ejected from the weapon barrel.

3. The security camera and weapon system of claim 1 the aiming indicia comprising cross-hairs, a position of the cross-hairs on the display screen controllable by the user.

4. The security camera and weapon system of claim 1 the weapon and the camera separately controllable as to a respective aiming or pointing direction.

5. The security camera and weapon system of claim 4 wherein pointing of the camera and aiming and firing of the weapon are controllable from a remote location.

6. The security camera and weapon system of claim 1, the display screen disposed remotely from the camera and the weapon.

7. The security camera and weapon system of claim 1 further comprising an audio channel further comprising a microphone at a location remote from the security camera and weapon system, and a speaker co-located with the camera, the audio channel for use by the user to provide a verbal message to a person in a field-of-view of the camera by speaking the message into the microphone, the message broadcast by the speaker.

8. The security camera and weapon system of claim 1 further comprising a software application resident on a smart phone or a processing device for executing software instructions, the software application for positioning the camera to cover a desired field of view.

9. The security camera and weapon system of claim 8 wherein positioning the camera comprises controlling a pan, tilt, and zoom operation of the camera.

10. The security camera and weapon system of claim 1 further comprising a software application resident on a smart phone or a processing device for executing software instructions, the software application comprising icons presented on the display screen for activation by the user for controlling the projectile aiming indicia and for firing the projectile.

11. The security camera and weapon system of claim 1 the system controller communicating over a wireless link with the camera for controlling the camera and communicating over a wireless link with the weapon to fire the projectile.

12. The security camera and weapon system of claim 1 wherein the system controller is located in a structure to which the camera and weapon have been mounted.

13. The security camera and weapon system of claim 1 the display screen capable of displaying images from a plurality of cameras.

14. The security camera and weapon system of claim 1 further comprising a microprocessor responsive to commands input to the microprocessor from the system controller for controlling the camera and for aiming and firing the weapon.

15. The security camera and weapon system of claim 1 further comprising an infrared detector disposed proximate the camera.

16. A security camera and weapon system, comprising:
a camera for capturing images of an area;
a display screen for displaying images captured by the camera;
a weapon co-located with the camera and controllable by a user to fire a projectile,
the projectile comprising:
a shell casing enclosing a projectile primer and a propellant;
primer contacts on an outside surface of the shell casing and in physical contact with the projectile primer;
application of a voltage to the primer contacts ignites the primer and thereby the propellant, causing the projectile to be ejected from a weapon barrel;
the camera controlled and the weapon aimed and fired by the user from a system controller executing a software application, the system controller comprising a smart phone or a processing device for executing software instructions associated with the software application, the software application for displaying a first icon for controlling camera pan, tilt, and zoom to cover a desired field of view, and a second icon for controlling a projectile aiming indicia and for firing the projectile, the projectile aiming indicia overlaid on images captured by the camera and presented on the display screen;
the weapon and the camera separately controllable as to a respective aiming or pointing direction; and
an audio channel further comprising a microphone at a location remote from the security camera and weapon system, and a speaker co-located with the camera, the audio channel for use by the user to provide a verbal message to a person in a field-of-view of the camera.

17. The security camera and weapon system of claim 16 further comprising a microprocessor responsive to commands input to the microprocessor from the system controller for controlling the camera and for aiming and firing the weapon.

18. The security camera and weapon system of claim 16 further comprising an infrared detector disposed proximate the camera.

19. A security camera and weapon system, comprising:
a camera for capturing images of an area;
a display screen for displaying images captured by the camera;
a weapon co-located with the camera and controllable by a user to fire a projectile, the weapon comprising primer contacts in contact with a projectile primer in contact with a propellant, the user controlling application of a voltage to the projectile primer, thereby igniting the projectile primer and thereby the propellant and firing the projectile from a weapon barrel; and
the weapon aimed and fired by the user from a system controller based on images captured by the camera and presented on the display screen, the images overlaid with projectile aiming indicia;
the system controller operated by the user, the system controller further comprising a smart phone or a processing device for executing software instructions associated with a software application;
the software application for displaying on the display screen a first icon for controlling camera pan, tilt, and zoom;
the software application for displaying on the display screen a second icon for controlling a projectile aiming indicia and for firing the projectile, the projectile aiming indicia overlaid on images captured by the camera; and
an audio channel further comprising a microphone at a location remote from the security camera and weapon system, and a speaker co-located with the camera, the audio channel for use by the user to provide a verbal message to a person in a field-of-view of the camera.

20. The security camera and weapon system of claim 19 further comprising a microprocessor responsive to commands input to the microprocessor from the system controller for controlling the camera and for aiming and firing the weapon.
